(19) United States
(12) Patent Application Publication
(10) Pub. No.: US 2014/0079939 A1
(43) Pub. Date: Mar. 20, 2014

(54) PRODUCING METHOD OF PLASMA POLYMERIZED FILM AND LAMINATED FILM, IMAGE FORMING METHOD, AND PLASMA POLYMERIZED FILM

(71) Applicant: Fujifilm Corporation, Tokyo (JP)

(72) Inventors: Naoyuki HAYASHI, Ashigarakami-gun (JP); Yoshio INAGAKI, Ashigarakami-gun (JP); Ryo FUJIWARA, Ashigarakami-gun (JP)

(73) Assignee: Fujifilm Corporation, Tokyo (JP)

(21) Appl. No.: 14/090,717

(22) Filed: Nov. 26, 2013

Related U.S. Application Data
(63) Continuation of application No. PCT/JP2012/063848, filed on May 30, 2012.

(30) Foreign Application Priority Data
Jun. 1, 2011 (JP) 2011-123427

(51) Int. Cl. C08F 2/46; C09D 11/00

(52) U.S. Cl. CPC C08F 2/46; C09D 11/30
USPC 428/220; 264/483; 427/488; 522/64; 522/33; 524/365

(57) ABSTRACT

A producing method of a plasma polymerized film includes irradiating a composition containing at least one kind of radically polymerizable compound, and at least one of a polymerization initiator and a chain transfer agent with plasma.

The plasma polymerized film is formed by polymerizing a composition containing at least one of a polymerization initiator and a chain transfer agent, and at least one kind of radically polymerizable compound by irradiation of plasma.

### BACKGROUND OF THE INVENTION

1. Field of the Invention

The present invention relates to a plasma polymerized film which is useful in various applications such as optical films and organic semiconductor films, and a method for producing the same. The present invention further relates to an image forming method using plasma polymerization.

2. Description of the Related Art

Traditionally, as a method for forming an organic thin film, the method in which polymerization of a coating film of monomers proceeds to form an organic thin film has been known. For polymerization of a coating film, photopolymerization or thermal polymerization is typically used. However, such a polymerization reaction is suppressed by oxygen, and accordingly, it has a problem that the degree of cure of the film surface that is in contact with the air atmosphere is lessened. Particularly, in the case where a coating liquid is coated on an organic thin film, thereby forming a laminated film, the surface of the organic thin film in the lower layer is dissolved in an organic solvent in the coating liquid, and the diffusion or mixing of undesired materials may occur at the coating interface in some cases. Correspondingly, the utility in organic transistors, organic photoreceptors, and the like, in which the structure of a film interface is critical, may be deteriorated in some cases. In addition, in a spray coating method or an ink jet method in which a form of mist or droplet is coated, the area of the interface between a coating liquid and air (specific surface area) is large, and accordingly, the amount of oxygen incorporated into the mist or the droplet increases, and in turn, polymerization suppression is more likely to occur.

Contrarily there has been a proposal to use plasma for a polymerization reaction. For example, in JP2009-25604A, there is a method for producing a polarizing plate-protecting film, in which a thin film of a polymerizable monomer having a predetermined thickness is formed on the surface of a base material of a polarizing plate-protecting film, and then irradiated with plasma under a pressure near the atmospheric pressure. In this method, the formation of a polymerized and cured film by irradiation of plasma and the hydrophobization of the surface is carried out at the same time. In addition, in [Chem. Mater., Vol. 22, p. 5653, 2010], a polymerization promoting agent is added to vinylpyrrolidone, followed by irradiation of plasma, to allow the polymerization of the mixture to proceed.

### SUMMARY OF THE INVENTION

Unlike a photopolymerization reaction or the like, in the polymerization by irradiation of plasma, the polymerization proceeds from the surface of a coating film that has been irradiated with plasma without inhibition by oxygen, and accordingly, the curability of the surface is improved, and thus it is advantageous. Contrarily, as investigated by the present inventors, when the thickness of a film is increased, the degree of cure of the interior of the film is decreased, and thus, peeling or the like easily occurs. In addition, as investigated by the present inventors, it has been found that in the method disclosed in [Chem. Mater., Vol. 22, p. 5653, 2010], the addition of a polymerization promoting agent serving to accelerate a polymerization speed brings issues that in the polymerization by irradiation of plasma, the polymerization speed increases excessively, gelling occurs while a solvent in a coating film is dried off, and thus, the solvent remains in the coating film.

It is an object of the present invention to improve the degree of cure of the surface of a polymerized and cured film in a coating film of monomers, while not reducing the degree of cure of the interior of the film.

That is, the object of the present invention is to provide a plasma polymerized film, in which both of the surface and the interior of the film exhibit a high degree of cure, and a method for producing the same.

It is another object of the present invention to provide a method capable of forming an image having excellent fixability, with no image transfer or the like.

In the producing method of a plasma polymerized film of the present invention, which could be a solution for the above-described problems, a composition containing at least one kind of radically polymerizable compound, and at least one of a polymerization initiator and a chain transfer agent is irradiated with plasma.

Preferably, a photopolymerization initiator is used as the polymerization initiator.

More preferably, a polymeric azo-based polymerization initiator is used as the polymerization initiator.

Still more preferably, the irradiation of plasma is carried out, using nitrogen gas plasma or helium gas plasma.

Even still more preferably, UV light is irradiated at the same time as the irradiation of plasma, or before and/or after the irradiation of plasma.

Even still more preferably, the radically polymerizable compound has two or more polymerizable groups in the molecule.

The producing method of a laminated film of the present invention includes at least producing a plasma polymerized film by the producing method of a plasma polymerized film of the present invention, and forming a film by coating using a coating liquid containing an organic solvent onto the surface of the plasma polymerized film.

The image forming method of the present invention includes arranging a composition including at least one of a polymerization initiator and a chain transfer agent, at least one kind of radically polymerizable compound, and an ink containing at least one kind of color material imagewise on the surface of a base material; and irradiating the composition with plasma to form an image formed of the plasma polymerized film.

Preferably, the ink is an aqueous ink and the radically polymerizable compound is a polyfunctional acrylamide-based monomer having an alkyleneoxy chain in the molecule.

The plasma polymerized film of the present invention is formed by polymerizing a composition containing at least one of a polymerization initiator and a chain transfer agent, and at least one kind of radically polymerizable compound by irradiation of plasma.

Preferably, the thickness is from 50 nm to 5000 nm.

More preferably, a photopolymerization initiator is used as the polymerization initiator.

Still more preferably, as the polymerization initiator, a polymeric azo-based polymerization initiator is used.

Even still more preferably, the irradiation of plasma is carried out, using nitrogen gas plasma or helium gas plasma.

Even still more preferably, the radically polymerizable compound has two or more polymerizable groups in the molecule.

Even still more preferably, the plasma polymerized film is formed by irradiation of plasma and irradiation of UV light.

According to the present invention, the degree of cure of the surface of the polymerized and cured film of the coating film of monomers can be improved, while not reducing the degree of cure of in the interior of the film.

That is, according to the present invention, a plasma polymerized film having the surface of a film and the interior of the film, both of which exhibit a high degree of cure, and a method for producing the same can be provided.

### DESCRIPTION OF THE PREFERRED EMBODIMENTS

Hereinafter, the present invention will be described in detail.

Further, in the specification, ranges with the numerical values indicated using “˜to˜” mean the ranges including the numerical values described before and after the “˜to˜” as the upper limit and the lower limit, respectively.

In addition, in the present specification, the terms “plasma polymerized film” and “cured film” are used, which are meant to include any of a film having a self-supporting property, a layer formed on a support, and a film.

1. Plasma Polymerized Film

The present invention relates to a plasma polymerized film which is formed by polymerizing a composition containing at least one of a polymerization initiator and a chain transfer agent, and at least one kind of radically polymerizable compound by irradiation of plasma. For the polymerization by irradiation of plasma, the polymerization proceeds by irradiation of gas which becomes plasma when introduced into a discharge space. Since the plasma includes a variety of active species generated by decomposition, excitation, activation, radical formation, ioniziation, and the like of the gas introduced into the discharge space, and the irradiation of plasma can activate the radically polymerizable compound, thereby allowing a radical polymerization reaction to proceed. Unlike photopolymerization or thermal polymerization, polymerization by irradiation of plasma is not inhibited from oxygen and a radical polymerization reaction proceeds from the surface of the film that has been irradiated with plasma, whereby a film having a high surface hardness can be formed. Contrarily, when the film thickness is high (for example, 50 nm or more), the radical polymerization reaction in the interior of the film does not sufficiently proceed, and accordingly, peeling from a base material or the like is likely to occur in certain cases. In the present invention, by subjecting a composition containing at least one of a polymerization initiator and a chain transfer agent, and at least one kind of radically polymerizable compound to plasma polymerization, a cured film having a high degree of cure of the surface of the film is provided, while not interfering with the curability of the interior of the film.

A preferable range of the polymerization initiator or the chain transfer agent to be added varies, depending on the film thickness or the like, but it is preferably 20% by mass or less, more preferably from 1% by mass to 10% by mass, and still more preferably from 2% by mass to 5% by mass, with respect to the radically polymerizable compound, for example, in order to form a cured film having a film thickness of 50 nm to 5000 nm. However, the present invention is not limited thereto.

Traditionally, for photopolymerization or thermal polymerization in the atmospheric air, when a film having a film thickness of 500 nm or less with a content of the polymerization initiator of about 1% by mass to 3% by mass with respect to the polymerizable compound, the polymerization rate is as low as about 20%, leading to a remarkably low film curing ability. For the plasma polymerized film of the present invention, when the content of the polymerization initiator is from about 1% by mass to 3% by mass with respect to the radically polymerizable compound, a polymerization rate of 60% or more of a plasma polymerized film having a thickness of 100 nm to 1000 nm can be accomplished.

The polymerization rate can be seen by measuring the infrared absorptions of the film before and after the polymerization reaction, and comparing the strength of the absorption peaks which are attributable to polymerizable groups.

The type of the polymerization initiator which can be used in the present invention is not particularly limited. Depending on the properties of plasma irradiated or the type of the discharge gas used for irradiation of plasma, a suitable polymerization initiator can be selected.

As the polymerization initiator of the present invention, a photopolymerization initiator or a thermal polymerization initiator is preferably used.

As the photopolymerization initiator, a known photopolymerization initiator can be used, and as the photopolymerization initiator which can be used in the present invention, a UV polymerization initiator which generates radicals or the like by irradiation of UV light is more preferably used since nitrogen plasma using nitrogen gas emits UV light. As the UV polymerization initiator, α-aminoketones, α-hydroxyketones, phosphine oxides, oxime esters, titanocenes, or the like can be used. Commercially available products (for example, IRGACURE 907, DAROCUR 1173, IRGACURE 184, IRGACURE 369, IRGACURE 379, IRGACURE 819, IRGACURE 784, IRGACURE OXE 01, and IRGACURE OXE 02, all manufactured by BASF Corp.) may also be used.

As a thermal polymerization initiator which generates radicals by heat, V-30, V-40, V-59, V-65, V-70, V-601, VF-096, VAm-110, and VAm-111 (all manufactured by Wako Pure Chemical Industries, Ltd.) or the like may be used, in addition to organic peroxides such as lauroyl peroxide and benzoyl peroxide, and azo-based polymerization initiators such as azobisisobutyro nitrile (AIBN).

For the composition containing a photopolymerization initiator, it is preferable to irradiate light (for example, irradiate UV light) at the same time as the irradiation of plasma, or before and/or after the irradiation of plasma, for further improvement of the degree of cure.

Moreover, according to the conditions of irradiation of plasma, or the like, heating may be performed so as to permit a thermal polymerization initiator to exert its action sufficiently in some case. In the present embodiment, by using a thermal polymerization initiator, the degree of cure can be improved. Further, for the composition containing a thermal polymerization initiator, heating may be performed at the same time as the irradiation of plasma, or before and/or after the irradiation of plasma.

The type of the chain transfer agent which can be used in the present invention is not particularly limited. The chain transfer agent can be selected from the chain transfer agents suitable for the radically polymerizable compounds that are used in combination therewith. For example, the chain transfer agent can be selected from compounds containing mercapto groups, and specific examples thereof include 3-mercaptopropyltrimethoxysilane, β-mercaptopropionic acid, methyl-3-mercaptopropionate, 2-ethylhexyl-3-mercaptopropionate, n-octyl-3 -mercaptopropionate, n-octylmercaptan, n-dodecylmercaptan, trimethylolpropanetris(3-mercaptopropionate), tris-[(3-mercaptopropionyloxy)-ethyl]-isocyanurate, tetraethylene glycol bis(3-mercaptopropionate), and an dipentaerythritolhexakis(3-mercaptopropionate).

In the case where a composition containing at least one of a polymerization initiator and a chain transfer agent, and at least one kind of radically polymerizable compound is prepared as a coating liquid, the coating liquid is coated to form a coating film, and the coating film is irradiated with plasma, non-uniformity is generated on the surface of the coating film by plasma gas (unevenness is generated on the surface of the coating film), the transparency is lost, and the haze is increased in some cases. In order to reduce the non-uniformity of the surface of the coating film due to plasma gas, the viscosity of the coating liquid is preferably increased, and a polymer contributing to an increase in the viscosity of the coating liquid is preferably used as at least one of a polymerization initiator and a chain transfer agent. That is, as the polymerization initiator, a polymeric-based polymerization initiator is preferably used, and a more preferable example of the polymerization initiator is a polymeric azo-based polymerization initiator.

Examples of the polymeric azo-based polymerization initiator of the present invention include a polymeric azo-based polymerization initiator having repeating units composed of azo groups and polymeric units (for example, polydimethylsiloxane units and polyethylene glycol units) to be introduced to both ends of the azo groups. The molecular weight of the polymeric units is preferably from 2000 to 10000, and more preferably from 5000 to 10000. Reference may be made to various specific examples of the polymeric azo-based polymerization initiator as described in “Fine Chemical, Vol. 39, No. 9, 47-52, 2010” or the like. Commercially available products (for example, VPS-1001, VPE-0201, VPE-0401, and VPE-0601, all manufactured by Wako Pure Chemical Industries, Ltd.) may also be used.

The radically polymerizable compound which can be used in the present invention is not particularly limited, but it is preferable to use a radically polymerizable compound having two or more polymerizable groups in the molecule, which makes it possible to form a crosslinked structure, from the viewpoint of film curing. Examples thereof include divinyl benzene, acrylamide-based monomers, polyethylene glycol dimethacrylates (NKester 1G, 2G, 3G, 4G, 9G, 14G, and 23G), polyethylene glycol diacrylates (NKester A-200, A-400, A-600, and A-1000), neopentyl glycol dimethacrylates (NKester 3PG, 9PG, APG-400, and APG-700), neopentyl glycol diacrylates (NKester APG-100, APG-200, APG-400, and APG-700), 1,6-hexanedioldimethacrylates (NKester HD-N), 1,6-hexanedioldiacrylates (NKester A-HD-N), 1,9-nonanedioldimethacrylates (NKester NOD-N,), 1,9-nonanedioldiacrylates (NKester A-NOD-N), 1,10-decanedioldimethacrylates (NKester DOD), 1,10-decanedioldiacrylates (NKester A-DOD), ethylene oxide-modified bisphenol A dimethacrylates (NKester BPE-80N, BPE-100N, BPE-200, BPE-500, BPE-900, and BPE-1300N), ethylene oxide-modified bisphenol A diacrylates (NKester ABE-300, A-BPE-4, A-BPE-6, A-BPE-10, A-BPE-20, and A-BPE-30), tricyclodecanedimethanol dimethacrylates (NKester DCP), tricyclodecanedimethanol diacrylates (NKester A-DCP), ethylene oxide-modified isocyanuric acid triacrylates (NKester A-9300), trimethylolpropane trimethacrylates (NKester TMPT), trimethylolpropane triacrylates (NKester A-TMPT), ethylene oxide-modified trimethylolpropane triacrylates (NKester A-TMPT-3EO), pentaerythritol tetraacrylates (NKester A-TMMT), ditrimethylolpropane tetraacrylates (NKester AD-TMP), and dipentaerythritol hexaacrylates (NKester A-DPH) (all manufactured by Shin-Nakamura Chemical Co., Ltd.), 1,4-butanediol diacrylates (V#195) and trisacryloyloxyethyl phosphates (V#3PA) (both manufactured by Osaka Organic Chemical Industry, Ltd.), polydimethylsiloxanes having vinyl-modified at both ends (DMS-V00, DMS-V03, DMS-V05, DMS-V21, DMS-V22, DMS-V25, DMS-V31, DMS-V33, DMS-V35, DMS-V41, DMS-V42, DMS-V46, DMS-V51, and DMS-V52), polysiloxanes having vinyl-modified at side chains (VDT-123, VDT-127, VDT-131, VDT-163, and VDT-431) (all manufactured by Gelest, Inc., trade name), and polydimethylsiloxanes having methacryl-modified at both ends (X-22-164, X-22-164AS, X-22-164A, X-22-164B, X-22-164C, and X-22-164E) (all manufactured by Shin-Etsu Chemical Co., Ltd.), but the present invention is not limited thereto.

Films formed by curing hydrophilic monomers by photopolymerization or thermal polymerization in the related art particularly tend to have poor solvent resistance of the surface, and as a result, the present invention is useful particularly in the embodiments using hydrophilic monomers as a radically polymerizable compound. Further, depending on the applications, the composition prepared as an aqueous coating liquid may be preferably used in some cases, but polymerization initiators which are sparingly soluble in water are also frequently present. In order to obtain a sufficient film curing degree, in the photopolymerization and thermal polymerization in the related art, to which a certain amount of a polymerization initiator needs to be added, the polymerization initiators which can be used together with the hydrophilic monomers are limited. In the present invention, plasma polymerization is used, and accordingly, the amount of the polymerization initiator to be added can be reduced and a polymerization initiator which can be contained in the composition prepared as an aqueous coating liquid can be selected from a wider range of polymerization initiators.

Examples of the hydrophilic monomer include monomers having polyoxyalkylene chains (for example, having repetition of 2 to 10 polyethyleneoxy units) in the molecule. For example, a radically polymerizable compound having an acrylamide group, an acryloyl group, or a methacroyl group linked with a polyoxyalkylene chain can be suitably used in the present invention. In the case where three or more polymerizable groups are contained in the molecule, three or more polyoxyalkylene chains having polymerizable groups at the ends may be linked by an alkylene group having a branched structure containing tertiary or quaternary carbon, or by a non-aromatic group (cycloalkylene or the like) or an aromatic cyclic group. Examples of these compounds include water-soluble polymerizable materials disclosed in Japanese Patent No. 4533295. The water-soluble polymerizable material described in Japanese Patent No. 4533295 is particularly useful in the image forming method as described later.

Moreover, since the plasma polymerized film of the present invention has a high degree of cure of the surface, an upper layer can be formed by coating a coating liquid, while not causing interfacial mixing, as described above. Accordingly, as the radically polymerizable compound used in the present invention, a radically polymerizable compound used as a raw material of a functional organic thin film laminates such as an organic transistor and an organic photoreceptor, and an organic thin film which constitute optical applications (optical extraction layers for organic EL elements) is preferred. Examples thereof include polyfunctional monomers having one or more carbazole skeletons, triarylamine skeletons, thiophene skeletons, fluorene skeletons, naphthalene skeletons, or the like in the molecule. Specifically, the compounds in which two or more linking groups having polymerizable groups at the end are bonded to those skeletons may be used. Examples of the linking group include C₁ to C₂₀ alkylene groups (provided that one carbon atom or two or more non-adjacent carbon atoms may be substituted with oxygen atoms, sulfur atoms, —COO—, OCO—, —NHCO—, —CONH—, or —CO—, and one —CH₂—CH₂— or two or more non-adjacent —CH₂—CH₂— may be substituted with —CH═CH— or —C↓C—), and a combination with aromatic hydrocarbon groups such as an alkylene group and a phenylene group, or heterocyclic groups. Examples of the polymerizable group include a vinyl group, an acryloyl group, and a methacryloyl group, and an acryloyl group or a methacryloyl group is more preferred. As a commercially available product thereof, NKester A-BPEF (manufactured by Shin-Nakamura Chemical Co., Ltd., trade name), Ac-N (manufactured by Kawasaki Kasei Chemicals Ltd., trade name), or the like may be used.

The composition used for the production of the plasma polymerized film of the present invention may contain one kind of radically polymerizable compound or two or more kinds of radically polymerizable compounds. Further, in the present invention, a composition containing at least one of a polymerization initiator and a chain transfer agent in combination with a radically polymerizable compound is used, but the composition may also contain other components. However, the composition preferably contains a radically polymerizable compound as a main component, more preferably in the amount of 80% by mass or more, or 90% by mass or more,

One example of the producing method of a plasma polymerized film of the present invention is a producing method of a plasma polymerized film, including irradiating a composition containing at least one of a polymerization initiator and a chain transfer agent, and at least one kind of radically polymerizable compound with plasma.

In the method, the composition is preferably prepared as a coating liquid. The solvent for use in the preparation of the coating liquid is not particularly limited, and an organic solvent can be used. Examples of the organic solvent which can be used include amides (for example, N,N-dimethylformamide), sulfoxides (for example, dimethyl sulfoxide), heterocyclic compound (for example, pyridine), hydrocarbons (for example, toluene, xylene, and hexane), alkyl halides (for example, chloroform and dichloromethane), esters (for example, methyl acetate and butyl acetate), ketones (for example, acetone, methylethylketone, and cyclohexanone), ethers (for example, tetrahydrofuran and 1,2-dimethoxyethane), and alcohols (for example, methanol, ethanol, and isopropyl alcohol). Alkyl halides and ketones are preferred. A combination of two or more kinds of the organic solvents may be used.

Next, the composition prepared as a coating liquid is coated on the surface of a substrate or the like and the solvent is removed by drying, thereby forming a coating film. The composition can be coated by an ordinary coating method, and the coating may be carried out by, for example, an ink jet method, a spray coating method, a spin coating method, an extrusion coating method, a direct gravure coating method, a reverse gravure coating method, a die coating method, or a bar coating method.

In the present invention, atmospheric-pressure plasma which is generated under the condition near the atmospheric pressure is preferably used. For example, a non-equilibrium plasma jet, low-temperature plasma by alternating current pulse discharge, and the like can be used, for all of which atmospheric-pressure plasma generated under the conditions near the atmospheric pressure is preferably used.

For the irradiation of plasma, various atmospheric-pressure plasma devices can be used. For example, a device capable of generating low-temperature plasma by performing intermittent discharge while passing an inert gas at a pressure near the atmospheric pressure between the electrodes covered with a dielectric, or the like is preferable, and various forms modified depending on the intended use or the like can be selected. More specific examples of the device include the device for a basic plasma treatment described in JP2008-60115A, the normal-pressure plasma device described in JP2004-228136A, and the plasma devices described in the specifications of JP2006-21972A, JP2007-188690A, and WO2005/062338A, WO2007/024134A, WO2007/145513A, and the like. Further, the atmospheric-pressure plasma device can be available as a commercially available product, and for example, ATMP-1000 manufactured by Arios Inc., an atmospheric-pressure plasma device manufactured by Haiden Laboratory, an 55000 type atmospheric-pressure low-temperature plasma jet device manufactured by SAKIGAKE-Semiconductor Co., Ltd., MyPL100 and ILP-1500, both manufactured by Well Co., Ltd., and RD550 manufactured by Sekisui Chemical Co., Ltd., and the like which are currently commercially available atmospheric-pressure plasma devices may also be suitably used. However, in order to reduce the damage on a coating film by a non-uniform concentration of plasma (streamer), for example, a device designed as an electric circuit, such that electricity supply to the discharge section is carried out via a pulse control element, described in each of the specifications of WO2005/062338A and WO2007/024134A.

Further, the “pressure near the atmospheric pressure” in the “atmospheric-pressure plasma” in the present invention refers to a range of 70 kPa to 130 kPa, and preferably a range of 90 kPa to 110 kPa.

As the discharge gas for use in the generation of the atmospheric-pressure plasma, mixed gases such as atmospheric air can also be used, but rare gas such as He and Ar, which is inert gas, or nitrogen gas (N₂) (all of which may be simply referred to as “inert gas” in some case) is preferably used, and He or N₂ is particularly preferred. By applying the plasma on the surface of the coating film, the polymerizable compound in the coating film is polymerized and cured with plasma to form a plasma polymerized film which is a cured film. By irradiating the surface of the coating film with plasma, a polymerization reaction rapidly initiates and proceeds. Further, in the polymerization by irradiation of plasma, active species (for example, radicals) contained in the plasma are adhered to the surface of the coating film, and the polymerization (for example, radical polymerization) initiates from the surface. That is, usually in the radical polymerization in the atmospheric air, the tackiness (stickiness) of the surface of the coating film is generated by polymerization inhibition by oxygen, and in the plasma polymerization, the polymerization degree in the surface of the coating film is high, and thus, the tackiness (stickiness) of the surface of the coating film is not generated.

Particularly, since the nitrogen gas plasma emits UV light, a polymerization reaction by irradiation of UV light can also proceed while a polymerization reaction by irradiation of plasma proceeds. Further, by generating heat by irradiation of plasma, a thermal polymerization reaction may also proceed in some cases. Incidentally, at the same time as the irradiation of plasma, or before or after the irradiation of plasma, irradiation of light (for example, UV light) or donation of heat may be carried out to accelerate the polymerization reaction. In the case of carrying out irradiation of nitrogen plasma, and in the case of carrying out irradiation of light at the same time as, before, or after the irradiation of plasma, it is preferable to add a light (UV) polymerization initiator (a polymerization initiator which generates radicals by irradiation of UV) to the composition. Further, in the case of using heat generation by irradiation of plasma, and in the case of carrying out heat donation at the same time as, before, or after the irradiation of plasma, it is preferable to add a thermal polymerization initiator to the composition.

However, the irradiation of plasma may be carried out in a batch mode or in an in-line mode having a connection with other steps.

From the viewpoint of inhibiting the damage on the surface of the coating film, it is effective to separate a plasma active site and a discharge site, or to inhibit local concentration (streamer) of plasma by the design of a discharge circuit, thereby generating uniform plasma. In particular, the latter is preferred, in which uniform irradiation of plasma (plasma treatment) can be performed over a large area. For the former, a mode for transporting the plasma generated by discharge to the surface of the coating film by the flow of an inert gas and bringing them into contact is preferred, and in particular, a so-called plasma jet mode is preferred. In this case, a path (conduit) for transporting inert gas including plasma is preferably constituted with dielectrics such as glass, ceramic, and an organic polymer. As the latter, a mode in which electricity supply is performed to an electrode covered with a dielectric via a pulse control element, thereby generating uniform glow plasma having streamer inhibited, described in the specification of WO2005/062338A and WO2007/024134A, is preferred.

The distance from a nozzle for supplying an inert gas including plasma to the surface of the coating film is preferably from 0.01 mm to 100 mm, and more preferably from 1 mm to 20 mm.

Also in the case of a transporting mode by an inert gas, plasma can be applied to the surface of the coating film in an in-line mode as described in the specification of WO2009/096785A. That is, a coating film for forming an organic thin film is formed by a coating method, and it becomes possible to form an organic thin film continuously by providing jetting nozzles or the like which can apply the inert gas and plasma to the surface of the coating film in the downstream in the coating step.

In the case of a plasma generating mode using an inert gas, the radically polymerizable compounds present in the coating film directly act on plasma, and thus, a polymerization reaction and a curing reaction initiate and proceed efficiently. As a result, even when a polymerization reaction requiring a closed based environment under an inert gas atmosphere for the purpose of suppression of the inhibition by oxygen is carried out in an open based environment, it is usually advantageous in that the reaction is not susceptible to the inhibition by oxygen, and thus, good curability can be accomplished.

Further, from the viewpoint of reducing the infiltration of chemical species derived from oxygen in the polymerization reaction, an inert gas may be sufficiently supplied to a region in which a plasma treatment is carried out, or the region may be filled with the inert gas. When the plasma is transported by such inert gas, it is preferable to flow the inert gas into the plasma generating region from a time prior to the plasma lighting-on, and continue to flow the inert gas even after the plasma lighting-off.

Regarding the inert gas after the plasma treatment, since the plasma has a short lifetime, the inert gas may be exhausted without further particular treatment. Alternatively, the inert gas after finishing the treatment may be recovered by providing a gas inlet in the vicinity of the treatment region.

As the temperature for irradiation of plasma, any temperature can be selected, depending on the properties of the materials in the coating film to be subject to irradiation of plasma. However, rather a smaller temperature rise caused by irradiation of the atmospheric-pressure plasma is preferred, which can reduce damage. By separating the region in which the plasma treatment is carried out from the plasma generating device, the effect is further improved.

In the plasma treatment, by selecting atmospheric-pressure low-temperature plasma and irradiating it, it is possible to reduce the supply of the heat energy from plasma and to suppress the temperature rise of the coating film. The temperature rise of the coating film due to the irradiation of plasma is preferably 50° C. or lower, more preferably 40° C. or lower, and particularly preferably 20° C. or lower.

The temperature in irradiation of plasma is preferably no higher than a temperature at which the materials in the coating film to be subjected to irradiation of plasma can withstand, and generally, it is preferably from −196° C. to lower than 150° C., more preferably from −21° C. to 100° C., and particularly preferably a temperature near room temperature (25° C.) under the environmental temperature atmosphere.

As described above, with the irradiation of plasma, unlike the thermal polymerization or the photopolymerization, polymerization inhibition by oxygen in the atmospheric air does not occur. Since the plasma polymerized film of the present invention which is formed by the irradiation of plasma has a high-density crosslinked structure formed thereon, the polymerization degree on the surface increases. Thus, in the case where a laminate (multilayer) structure is formed by a coating method, the diffusion or mixing into the undesired adjacent layer at the interface of the coating film is inhibited.

Therefore, in the producing method of a plasma polymerized film of the present invention, the compatibility at the interface with the adjacent layer, which is usually problematic in a coating method or the diffusion of low-molecular-weight components is inhibited, and as a result, a plasma polymerized film having a multilayer structure can be produced at high productivity by a coating method or a continuous method.

Moreover, a carboxyl group, a hydroxyl group, a nitrile group, an amide group, and the like (derived from oxygen molecules, water molecules, nitrogen molecules, ammonia molecules) may be introduced to the surface of the film and a part thereof at the same time as the polymerization by the irradiation of plasma in some cases. The introduction of such a hydrophilic group into the surface of the film improves the wettability in the coating liquid and the adhesiveness to the coating liquid when other layers (for example, a barrier layer/a sealing layer) are coated and formed on the film, and therefore, it is advantageous in that lamination is facilitated.

The surface hydrophilicity can be indentified with an indicator of a contact angle of water. The surface of the plasma polymerized film of the present invention preferably has a water contact angle (a contact angle when 2 μL of pure water is added dropwise, calculated as an average value of about 10 places), exhibiting a hydrophilicity of 80° or less, more preferably a hydrophilicity of 30 to 70°, and still more preferably a hydrophilicity of 35 to 65°. The polymerizable compound having a carbazole skeleton, a triarylamine skeleton, a thiophene skeleton, a fluorene skeleton, a naphthalene skeleton, or the like is generally oil-soluble, and a cured film formed by the curing by the photopolymerization or the thermal polymerization of a composition including an oil-soluble polymerizable compound as a main component in the related art generally has a hydrophobic surface and has a water contact angle of the surface exceeding 80°. Although the plasma polymerized film of the present invention has an oil-soluble radically polymerizable compound as a main component, it may exhibit hydrophilicity (even when no surface treatment is carried out).

The thickness of the plasma polymerized film of the present invention is not particularly limited. In the producing method, a plasma polymerized film having a film thickness of 50 nm to 5000 nm (more preferably 100 nm to 5000 nm, and still more preferably 500 nm to 5000 nm) can be stably produced, but the present invention is not limited to these ranges.

The plasma polymerized film of the present invention can also be formed on a support. As the support, a glass plate, a metal plate, various polymer films, or the like can be used.

The plasma polymerized film of the present invention can be used in various applications. For example, it can be used in optical films such as optical compensation films in liquid crystal display devices. Further, it can be used as an organic semiconductor layer of an organic transistor and the like. The polymerization initiator remaining in the plasma polymerized film can be a factor in carrier trapping, but in the plasma polymerization, the amount of the polymerization initiator used can be reduced, as compared with the photopolymerization in the related art, and thus, an improvement in the carrier trapping performance is expected. The plasma polymerized film is particularly effective as an organic semiconductor layer of a bottom gate type transistor since it can reduce the effects of decomposition by irradiation of plasma.

Moreover, the producing method of a plasma polymerized film of the present invention is effective for reduction of the surface tackiness due to reduction of the polymerization suppression of the surface or improvement of the degree of cure of the surface in a spray coating method or an ink jet method in which a form of mist or droplet is coated, and image rubbing or image stain, generated when the printed sheets of paper are superimposed, can be reduced. That is, the producing method of a plasma polymerized film of the present invention can be used as an image forming method by a spray coating method or an ink jet method. In the method, an ink containing a color material (a pigment, a dye, and the like), together with a polymerization initiator and/or a chain transfer agent, and a radically polymerizable compound can be used. Examples of the pigment include known materials such as C. I. Pigment Yellow 13 (PY13), C. I. Pigment Red 17 (PR17), and C. I. Pigment Blue 56 (PB56). Further, examples of the dye include known materials such as C. I. Acid Yellow 23 (AY23), C. I. Direct Yellow 44 (DY44), C. I. Direct Yellow 142 (DY142), C. I. Acid Red 289 (AR289), C. I. Acid Red 249 (AR249), C. I. Acid Red 35 (AR35), C. I. Acid Red 87 (AR87), C. I. Acid Red 276 (AR276), C. I. Direct Red 79 (DR79), C. I. Acid Blue 9 (AB9), C. I. Direct Blue 86 (DB86), C. I. Direct Blue 168 (DB168), C. I. Acid Black 24 (ABk24), C. I. Acid Black 26 (ABk26), C. I. Acid Black 2 (ABk2), C. I. Direct Black 19 (DBk19), and C. I. Direct Black 154 (DBk154). The content of the color material in the composition is preferably from 0.5% by mass to 20% by mass, and more preferably from 2% by mass to 10% by mass.

That is, one embodiment of the present invention is an image forming method including arranging a composition including at least one of a polymerization initiator and a chain transfer agent, and at least one kind of radically polymerizable compound, and an ink containing at least one color material on the surface of a base material (for example, paper or a polymer film) imagewise; and irradiating the composition with plasma to form an image including a plasma polymerized film.

As a method for forming an image by arranging the ink on the surface of a base material, an ink jet method, a spray coating method, or the like can be used.

As the ink, an aqueous ink can be used. In the present invention, even when the amount of the polymerization initiator added is reduced, a sufficient film curing degree can be obtained, and as a result, even a polymerization initiator having a low water solubility may be used. The hydrophilic monomer which can be used as a radically polymerizable compound is as described above, and is preferably a polyfunctional radically polymerizable compound having an alkyleneoxy chain in the molecule. Among these, an acrylamide-based monomer having an alkyleneoxy chain in the molecule is preferred, and aqueous polymerizable materials described in, for example, Japanese Patent No. 4533205 may be used. However, the present invention is not limited thereto.

### EXAMPLES

Hereinafter, the present invention will be described in more detail with reference to Examples. The materials, the reagents, the amounts and ratios of the materials, the operations, and the like shown in Examples below may be appropriately modified while not departing from the spirit of the present invention. Accordingly, the scope of the present invention is not limited to the following specific examples.

### 1. Examples 1 to 4 and Comparative Examples 1 to 3

### (1) Example 1

20 parts by mass of an acrylamide-based polymerizable compound (1) shown below, described in Journal of Polymer Science: Part A. Polymer Chemistry, Vol. 47, p. 2664, 2009, and 0.4 parts by mass of a photo (UV)-polymerization initiator were dissolved in methanol to prepare a coating liquid.

A coating film having a film thickness of 500 nm was formed by coating the coating liquid on a copper foil by a spin coating method.

(Plasma Treatment)

The coating film was irradiated with low-temperature N₂ plasma for 30 seconds, using an S5000 type atmospheric-pressure low-temperature plasma jet device (discharge gas: nitrogen), manufactured by SAKIGAKE Semiconductor Ltd., and the coating film was subjected to a polymerization reaction and curing to form a plasma polymerized film having a film thickness of 500 nm.

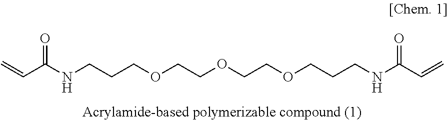 [SMILES: C=CC(=O)NCCCOCCOCCOCCCNC(=O)C=C]

### (2) Example 2

In the same manner as in Example 1 except that the discharge gas was changed to helium gas (He gas) and the He gas plasma was irradiated, a plasma polymerized film having a film thickness of 500 nm was formed.

### (3) Comparative Example 1

In the same manner as in Example 1 except that a solution containing no photopolymerization initiator as a coating liquid was prepared, a plasma polymerized film having a film thickness of 500 nm was formed.

### (4) Comparative Example 2

In the same manner as in Example 1, a coating film having a thickness of 500 nm was formed and irradiated with UV, using UV LIGHT SOURCE EX250 (manufactured by HOYA-SCHOTT Corp.) as a UV lamp such that the UV irradiation dose was 1 J/cm² in an atmospheric air.

### (5) Examples 3 and 4, and Comparative Example 3

In the same manner as in Example 1 except that the coating amount applied on a copper foil in Example 1 was changed to form a plasma polymerized film having a thickness of 1000 nm, a plasma polymerized film of Example 3 was formed.

Further, in the same manner as in Example 1, a coating film was formed, then irradiated with UV in the atmospheric air, and then irradiated with plasma to form a plasma polymerized film of Example 4

In the same manner as in Comparative Example 1 except that the coating amount to be coated on the copper foil in Comparative Example 1 was changed to form a plasma polymerized film having a thickness of 1000 nm, a plasma polymerized film of Comparative Example 3 was formed.

### (6) Evaluation of Performance

(6)-1 Surface Tackiness

A PET (polyethylene terephthalate) film (film thickness of 50 μm) was attached on the surface of each of the plasma polymerized films formed above, and then detached. The presence or absence of foreign matter (film components) on the PET film was observed, using a digital microscope VHX-100 (manufactured by Keyence Corp.).

The presence or absence of adhesion of foreign matter onto the PET film will be an indicator of the degree of cure of the surface of the plasma polymerized film. No occurrence of adhesion of foreign matter onto the PET film indicates a film having a high degree of cure of the surface, whereas the presence of foreign matter on the PET film indicates a film having a low degree of cure of the surface.

The surface tackiness was evaluated in accordance with the following criteria.

A: There is no adhesion of foreign matter onto the PET film, the degree of cure of the surface is high, and there is no surface tackiness.

B: There is adhesion of foreign matter onto the PET film, the degree of cure of the surface is low, and there is surface tackiness.

(6)-2 Cross-Cut Adhesion Test

A cross-cut having a 1-mm pitch was fabricated in accordance with JIS K-5400:1990. A cellophane adhesive tape having a width of 24 mm was attached thereto and then detached, and the number of the coating film adhered to the tape was counted.

The presence or absence of adhesion to the tape will be an indicator of the degree of cure of the interior of the film. It can be said that a larger number of the films adhered to the tape indicates a film having a lower degree of cure of the interior of the film.

The cross-cut adhesion test was evaluated in accordance with the following criteria.

A: The number of the coating films adhered to the tape is from 0 to 10.

B: The number of the coating films adhered to the tape is from 11 to 20.

C: The number of the coating films adhered to the tape is from 21 to 100.

(6)-3 Evaluation 1 of Solvent Resistance

100 μL of isopropyl alcohol was added dropwise to the surface of the plasma polymerized films and the polymerized films in Comparative Examples, and spin-coated at a rotation speed of 200 rpm for 20 seconds. The film thickness before and after the addition of isopropyl alcohol was measured, using a film thickness meter XP-200 (Ambios, trade name) (25° C.), and the variation rate was calculated.

Further, the polymerization rate of each plasma polymerized film was calculated by measuring the infrared absorption of the plasma polymerized film before and after the polymerization reaction, using Varian 3100 FT-IR (manufactured by VARIAN Inc.), and comparing the intensities at a wave number of 987 cm⁻¹.

The results are shown in Tables below.

TABLE 1
Film thickness: 500 nm

| | | | | | | Cross-cut | Evaluation |
|---|---|---|---|---|---|---|---|
| | Polymerization initiator/ | | Treatment | Polymerization | Surface | adhesion | 1 of solvent |
| | Chain transfer agent | | method | rate | tackiness | test | resistance |
| Comparative | — | | Irradiation | 65% | A | B | Increase in |
| Example 1 | | | of nitrogen | | | | film |
| | | | plasma | | | | thickness |
| | | | | | | | (swollen) |
| Example 1 | UV | IRGACURE | Irradiation | 83% | A | A | No change |
| | polymerization | 2959 | of nitrogen | | | | in film |
| | initiator | | plasma | | | | thickness |
| Example 2 | UV | IRGACURE | Irradiation | 80% | A | A | No change |
| | polymerization | 2959 | of He | | | | in film |
| | initiator | | plasma | | | | thickness |
| Comparative | UV | IRGACURE | Irradiation | 22% | B | A | Decrease in |
| Example 2 | polymerization | 2959 | of UV | | | | film |
| | initiator | | | | | | thickness |

TABLE 2
Film thickness: 1000 nm

| | | | | | | Cross-cut | Evaluation |
|---|---|---|---|---|---|---|---|
| | Polymerization initiator/ | | Treatment | Polymerization | Surface | adhesion | 1 of solvent |
| | Chain transfer agent | | method | rate | tackiness | test | resistance |
| Comparative | — | | Irradiation | 12% | A | C | Decrease |
| Example 3 | | | of nitrogen | | | | in film |
| | | | plasma | | | | thickness |
| Example 3 | UV | IRGACURE | Irradiation | 68% | A | A | No change |
| | polymerization | 2959 | of nitrogen | | | | in film |
| | initiator | | plasma | | | | thickness |
| Example 4 | UV | IRGACURE | Irradiation | 89% | A | A | No change |
| | polymerization | 2959 | of UV + | | | | in film |
| | initiator | | irradiation | | | | thickness |
| | | | of nitrogen | | | | |
| | | | plasma | | | | |

### 2. Example 5 and Comparative Example 4

### (1) Example 5

13 parts by mass of zirconium oxide fine particles (average primary particle diameter of 15 nm) and 1.3 parts by mass of a dispersion material (4-octylbenzoic acid) were mixed together in 10 parts by mass of toluene, and the mixture was sufficiently stirred and dispersed, using an Omni mixer and an ultrasonic disperser, to obtain a zirconium oxide dispersion.

24.3 parts by mass of a zirconium oxide dispersion, 10 parts by mass of a bifunctional monomer (2) shown below (“NK ester A-BPEF” manufactured by Shin-Nakamura Chemical Co., Ltd., trade name), and 6 parts by mass of toluene were stirred by a stirrer and dissolved. Further, zirconium oxide particles were sufficiently dispersed therein by an ultrasonic disperser to obtain a monomer coating liquid precursor.

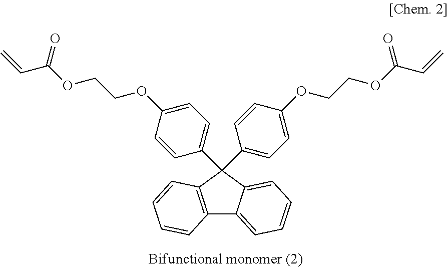 [SMILES: C=CC(=O)OCCOc1ccc(C2(c3ccc(OCCOC(=O)C=C)cc3)c3ccccc3-c3ccccc32)cc1]

Subsequently, 4.2 parts by mass of crosslinked resin fine particles MX 150 (manufactured by Soken Chemical & Engineering Co, Ltd, particle diameter 1.5 μm) and 14 parts by mass of toluene were mixed into 20 parts by mass of the monomer coating liquid precursor, and the mixture was stirred and dispersed, using a stirrer and an ultrasonic disperser. Further, 0.3 parts by mass of a photo (UV)-polymerization initiator “IRGACURE 819” (manufactured by BASF Corp.) was dissolved in the dispersion to prepare a coating liquid.

The coating liquid was coated on a UV-ozone treated glass substrate having a surface treated with a methacryl-modified silane coupling agent “KBM-503” (manufactured by Shin-Etsu Chemical Co., Ltd.) to form a film which has a thickness of 5 μm by a bar coating method. Using a UV exposure machine “ECS-401 GX” (light source: a metal halide lamp, manufactured by Eye Graphics Co., Ltd.), irradiation was carried out in the atmospheric air at an UV irradiation dose of 2 J/cm², and further, irradiation of nitrogen plasma was carried out by the method described in Example 1. In addition, heating was carried out at 120° C. for 30 minutes to form a plasma polymerized film.

### (2) Comparative Example 4

In the same manner as in Example 5 except that the irradiation of plasma was not carried out in Example 5, a polymerized film of Comparative Example 4 was formed.

### (3) Evaluation of Performance

For the polymerized films thus obtained, the surface tackiness, the cross-cut adhesion test, and the evaluation 1 of solvent resistance were carried out in the same manner as in Example 1.

Evaluation 2 of Solvent Resistance:

The surface of the plasma polymerized films and the polymerized films of Comparative Examples was wiped with a cotton swab dampened with isopropyl alcohol, and the solvent resistance was evaluated.

A: Nothing is adhered to the cotton swab and there is solvent resistance.

B: Something is adhered to the cotton swab and there is no solvent resistance.

The results are shown in Tables below.

TABLE 3

| | | | | | Cross-cut | Evaluation | Evaluation |
|---|---|---|---|---|---|---|---|
| | Polymerization initiator/ | | Treatment | Surface | adhesion | 1 of solvent | 2 of solvent |
| | Chain transfer agent | | method | tackiness | test | resistance | resistance |
| Example 5 | UV | IRGACURE | Irradiation | A | A | No change | A |
| | polymerization | 819 | of nitrogen | | | in film | |
| | initiator | | plasma + | | | thickness | |
| | | | irradiation | | | | |
| | | | of UV | | | | |
| Comparative | UV | IRGACURE | Irradiation | A | A | No change | B |
| Example 4 | polymerization | 819 | of UV | | | in film | |
| | initiator | | | | | thickness | |

In Example 5, it can be understood that the surface of the film was sufficiently cured from the viewpoint that there was no surface tackiness and the solvent resistance was good. Further, it can be understood that the interior of the film was also sufficiently cured from the cross-cut adhesion test.

Contrarily, in Comparative Example 4, it can be understood that the polymerization inhibition by oxygen occurs and the polymerization of the surface of the film was not sufficient since the bifunctional monomers (2) has a low solubility in isopropyl alcohol, a change in the film thickness was not observed, and the evaluation 2 of solvent resistance was not good.

Further, the plasma polymerized film of Example 5 can be used as a light extraction layer of an organic EL element.

### 3 Example 6 and Comparative Example 5

### (1) Example 6

(Preparation of Ink)

20 parts by mass of a PB-15 1 pigment dispersion (pigment concentration 9% by weight), 20 parts by mass of the following bifunctional acrylamide-based monomer (3), and 58 parts by mass of pure water were stirred by a stirrer, dissolved, and further ultrasonic wave-treated by an ultrasonic wave disperser to prepare an ink precursor for ink jet. Then, 1 part by mass of a photo (UV)-polymerization initiator: IRGACURE 2959 (manufactured by BASF Corp.) was dissolved therein to prepare an ink for ink jet.

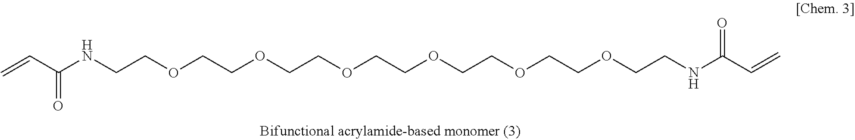 [SMILES: C=CC(=O)NCCOCCOCCOCCOCCOCCOCCNC(=O)C=C]

(Coating/Film Curing)

Using an ink jet printer DMP 2831, the ink was printed on PPC paper (Fuji Xerox paper) and dried in a thermostatic chamber at 60° C. to obtain a solid image having a thickness of 4 μm. Using a UV exposure machine ECS-401 GX (light source: a metal halide lamp, manufactured by Eye Graphics Co., Ltd.), irradiation was carried out in the atmospheric air at an UV irradiation dose of 2 J/cm², and further, irradiation of nitrogen plasma was carried out by the method described in Example 1.

### (2) Comparative Example 5

In the same manner as in Example 6 except that the irradiation of plasma was not carried out in Example 6, a polymerized film of Comparative Example 5 was formed.

### (3) Evaluation

For the plasma polymerized films formed above and the polymerized films of Comparative Examples, in the same manner as in Examples 1 and 5, the surface tackiness, the cross-cut adhesion test, the evaluation 1 of solvent resistance, and the evaluation 2 of solvent resistance were carried out, respectively. The results are shown in Tables below.

TABLE 4

| | | | | | Cross-cut | Evaluation | Evaluation |
|---|---|---|---|---|---|---|---|
| | Polymerization initiator/ | | Treatment | Surface | adhesion | 1 of solvent | 2 of solvent |
| | Chain transfer agent | | method | tackiness | test | resistance | resistance |
| Example 6 | UV | IRGACURE | Irradiation | A | A | No change | A |
| | polymerization | 2959 | of nitrogen | | | in film | |
| | initiator | | plasma + | | | thickness | |
| | | | irradiation | | | | |
| | | | of UV | | | | |
| Comparative | UV | IRGACURE | Irradiation | A | A | Decrease | B |
| Example 5 | polymerization | 2959 | of UV | | | in film | |
| | initiator | | | | | thickness | |

In Example 6, it can be understood that the surface of the film was sufficiently cured from the viewpoint that there was no surface tackiness and the solvent resistance was good. Further, from the cross-cut adhesion test, it can be understood that the interior of the film was also sufficiently cured. Contrarily, in Comparative Example 5, it can be understood that the solvent resistance was low, the polymerization inhibition by oxygen occurred, and the polymerization of the surface was not sufficient.

From the results above, it was confirmed that even with the use of an ink jet method, a plasma polymerized film which the surface of the film and the interior of the film are sufficiently cured could be obtained. That is, by the present invention, an image forming method with which the fixability is good while not involving image transfer or the like can be provided.

### 4. Examples 7 and 8, and Comparative Examples 6 and 7

### (1) Example 7

20 parts by mass of a bifunctional acryl monomer (4) (“NKester A-BPE-20”, manufactured by Shin-Nakamura Chemical Co., Ltd.) and 0.4 parts by mass of a polymeric azo-based polymerization initiator (“VPE-0201” manufactured by Wako Pure Chemical Industries, Ltd.) were dissolved in 400 parts by mass of methyl ethyl ketone to prepare a coating liquid.

The coating liquid was coated on a UV-ozone treated glass substrate having a surface treated with a methacryl-modified silane coupling agent “KBM-503” (manufactured by Shin-Etsu Chemical Co., Ltd.) to have a film which has a thickness of 500 nm by a spin coating method. Treatment with nitrogen plasma was carried out in the same manner as in Example 1, and heating and drying were carried out at 80° C. for 5 minutes, using a hot plate in the atmospheric air, to form a plasma polymerized film.

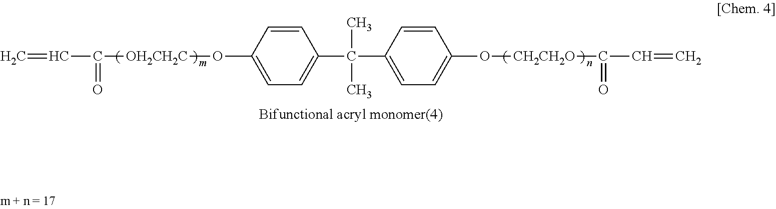

### (2) Example 8

In the same manner as in Example 7 except that a chain transfer agent: 3-mercaptopropyltrimethoxysilane KBM-803 (Shin-Etsu Chemical Co., Ltd., trade name) was added, instead of the polymeric azo-based polymerization initiator in Example 7, a plasma polymerized film was formed.

### (3) Comparative Examples 6 and 7

In the same manner as in Example 7 except that the treatment of irradiation of plasma was not carried out in Example 7, the polymerized film of Comparative Example 6 was formed.

In the same manner as in Example 8 except that the treatment of irradiation of plasma was not carried out in Example 8, the polymerized film of Comparative Example 7 was formed.

### (4) Evaluation

In the same manner as in Examples 1 to 3, for the each of the plasma polymerized films and each of the polymerized films of Comparative Examples, the surface tackiness, the cross-cut adhesion test, and the evaluation 1 of solvent resistance were carried out, respectively. The results are shown in Tables below.

TABLE 5

| | | | | | Cross-cut | Evaluation |
|---|---|---|---|---|---|---|
| | Polymerization initiator/ | | Treatment | Surface | adhesion | 1 of solvent |
| | Chain transfer agent | | method | tackiness | test | resistance |
| Example 7 | Thermal | VPE-0201 | Irradiation | A | A | There is no |
| | polymerization | | of nitrogen | | | change in |
| | initiator | | plasma + | | | film |
| | | | heating | | | thickness |
| Example 8 | Chain transfer | Mercaptotrimethoxy | Irradiation | A | A | There is no |
| | agent | silane | of nitrogen | | | change in |
| | | | plasma + | | | film |
| | | | heating | | | thickness |
| Comparative | Thermal | WE-0201 | Heating | — | — | — |
| Example 6 | polymerization | | | | | |
| | initiator | | | | | |
| Comparative | Chain transfer | Mercaptotrimethoxy | Heating | — | — | — |
| Example 7 | agent | silane | | | | |

In Examples 7 and 8, it can be understood that the surface of the film was sufficiently cured from the viewpoint that there was no surface tackiness and the solvent resistance is good. Further, from the cross-cut adhesion test, it can be understood that the interior of the film was also sufficiently cured. Contrarily, in Comparative Examples 6 and 7, since the film was not cured due to polymerization inhibition, any evaluation could not be conducted.

The present application is a continuation application of International Application No. PCT/JP2012/063848, filed Sep. 21, 2012, which claims priority to Japanese Patent Application No. 2011-123427, filed Jun. 1, 2011. The contents of these applications are incorporated herein by reference in their entirety.

What is claimed is:

1. A producing method of a plasma polymerized film, in which a composition containing at least one kind of radically polymerizable compound, and at least one of a polymerization initiator and a chain transfer agent is irradiated with plasma.

2. The method according to claim 1, wherein a photopolymerization initiator is used as the polymerization initiator.

3. The method according to claim 1, wherein a polymeric azo-based polymerization initiator is used as the polymerization initiator.

4. The method according to claim 1, wherein the irradiation of plasma is carried out, using nitrogen gas plasma or helium gas plasma.

5. The method according to claim 1, wherein UV light is irradiated at the same time as the irradiation of plasma, or before and/or after the irradiation of plasma.

6. The method according to claim 2, wherein UV light is irradiated at the same time as the irradiation of plasma, or before and/or after the irradiation of plasma.

7. The method according to claim 1, wherein the radically polymerizable compound has two or more polymerizable groups in the molecule.

8. A producing method of a laminated film, comprising at least:
producing a plasma polymerized film by the method according to claim 1; and
forming a film by coating using a coating liquid containing an organic solvent onto the surface of the plasma polymerized film.

9. A image forming method comprising:
arranging a composition including at least one of a polymerization initiator and a chain transfer agent, at least one kind of radically polymerizable compound, and an ink containing at least one kind of color material imagewise on the surface of a base material; and
irradiating the composition with plasma to form an image formed of the plasma polymerized film.

10. The method according to claim 9, wherein the ink is an aqueous ink and the radically polymerizable compound is a polyfunctional acrylamide-based monomer having an alkyleneoxy chain in the molecule.

11. A plasma polymerized film formed by polymerizing a composition containing at least one of a polymerization initiator and a chain transfer agent, and at least one kind of radically polymerizable compound by irradiation of plasma.

12. The plasma polymerized film according to claim 11, wherein the thickness is from 50 nm to 5000 nm.

13. The plasma polymerized film according to claim 11, wherein a photopolymerization initiator is used as the polymerization initiator.

14. The plasma polymerized film according to claim 11, wherein a polymeric azo-based polymerization initiator is used as the polymerization initiator.

15. The plasma polymerized film according to claim 11, wherein the irradiation of plasma is carried out, using nitrogen gas plasma or helium gas plasma.

16. The plasma polymerized film according to claim 11, wherein the radically polymerizable compound has two or more polymerizable groups in the molecule.

17. The plasma polymerized film according to claim 11, wherein the plasma polymerized film is formed by irradiation of plasma and irradiation of UV light.

18. The plasma polymerized film according to claim 13, wherein the plasma polymerized film is formed by irradiation of plasma and irradiation of UV light.
